(19) United States
(12) Patent Application Publication
(10) Pub. No.: US 2016/0037733 A1
(43) Pub. Date: Feb. 11, 2016

(54) MODULAR WALL SYSTEM FOR VERTICAL GARDENS

(71) Applicant: MODIWALL (PTY) LIMITED, Centurion, Guateng (ZA)

(72) Inventors: Charl BAKER, Centurion, Guateng (ZA); Paul Rudolph SMIT, Centurion, Guateng (ZA); Willem Gert DU TOIT, Centurion, Guateng (ZA)

(21) Appl. No.: 14/779,093

(22) PCT Filed: Mar. 12, 2014
(86) PCT No.: PCT/IB2014/059670

§ 371 Date: Sep. 22, 2015

(30) Foreign Application Priority Data
Mar. 22, 2013 (ZA) 2013/02152

(51) Int. Cl. A01G 9/02; A01G 27/00

(52) U.S. Cl. CPC A01G 9/025; A01G 27/005

(57) ABSTRACT

The invention provides a modular wall system [10] which is adapted for supporting a vertical garden. The modular wall system [10] comprises a supporting wall [12] comprising first liquid guiding means [16] for guiding water, liquid nutrient feedstock and the like in the wall [12], and first engaging means [18] for engaging a plant container [14] in various different positions on the supporting wall [12]. The modular wall system [10] also comprises at least one plant container [14] for housing plant material, wherein the plant container [14] comprises second engaging means [32] for releasably engaging the supporting wall [12], and second liquid guiding means [34, 36] extending from the plant container [14] into the first liquid guiding means [16] and dimensioned for guiding liquid from the first liquid guiding means [16] in the supporting wall [12] into the plant container [14].

### INTRODUCTION TO THE INVENTION

This invention relates to a modular wall system adapted for supporting a vertical garden, both indoors and outdoors.

### BACKGROUND TO THE INVENTION

A “living wall” or “vertical garden”, which is also referred to as a green wall, bio-wall or vertical vegetated complex wall, is a wall, either free-standing or as part of a building, which is partially or completely covered with vegetation and, in some cases, soil or an inorganic growing medium. Vertical gardens can be designed into water features, landscapes, buildings and intimate urban yards and is becoming increasingly popular in the design of modern-day structures where space is often limited, but where the benefit of “green living” is highly sought after by architects, business owners and homeowners alike.

Those who are engaged in the landscaping industry will appreciate that vertical garden systems typically incorporate a so-called “matt pocket and bag” method. However, this arrangement suffers from a number of disadvantages, such as (i) it can only house a relatively small amount of growing medium, which limits plant growth and life over time; (ii) it requires liquid nutrients to extend plant growth and life due to unnatural growing conditions; (iii) unpleasant odors being created by the use of significant amounts of liquid nutrients; (iv) requiring relatively high maintenance to maintain irrigation and encourage healthy plant growth; (v) requiring expensive matt pocket and bag kits; (vi) having a relative high watering demand to encourage plant growth and to keep plants hydrated; and (vii) being relatively difficult to manufacture, install and maintain.

Additional problems associated with vertical gardens include uneven water distribution through the wall, as water is required to trickle downwardly from a top of the wall through the growing medium for the width and height of the wall that is covered by plants. If the water is not evenly distributed some plants may be over-watered, while other plants in the wall may be under-watered. Moreover, existing systems for vertical gardens seldom provide for interchangeability in its design, at least not without significant difficulty—once the plants are in place, they can generally not be moved easily to manipulate the design of such a living wall.

The applicant has developed a modular wall system adapted for supporting a vertical garden which is easy to install and to clean; allows for easy exchange of plants to remove dead or dying plants or simply to change a design, for example to accommodate seasonal changes or for marketing purposes (e.g. to reflect a company's logo on a living wall by using different colored plants); and assures even distribution of water throughout the system; while at the same time reducing overall water usage.

### SUMMARY OF THE INVENTION

According to the invention there is provided a modular wall system adapted for supporting a vertical garden, the modular wall system comprising—
a supporting wall comprising first liquid guiding means for guiding water, liquid nutrient feedstock and the like in the wall, and first engaging means for engaging a plant container in various different positions on the supporting wall; and
at least one plant container for housing plant material, the plant container comprising second engaging means for releasably engaging the supporting wall, and second liquid guiding means extending from the plant container into the first liquid guiding means and dimensioned for guiding liquid from the first liquid guiding means in the supporting wall into the plant container.

The modular wall system is designed such that a plurality of supporting walls can engage each other to form different structures, depending on on-site design requirements. In particular, the supporting wall may include connecting means for releasably connecting one supporting wall to a neighboring supporting wall, either in a horizontal plane or in a vertical plane, the arrangement being such that neighboring supporting walls may pivotally and slidingly be displaceable relative to each other.

The supporting wall may be an upright, free standing wall, which may optionally be secured to a wall of a building or other rigid structure. The supporting wall may comprise a first panel, which includes the first liquid guiding means, and a second panel, which includes the first engaging means for engaging the plant container. The first and second panels may releasably be connectable to each other. Alternatively, the first and second panels may integrally be formed as a single unit.

The first liquid guiding means may be a channel or groove extending vertically down the first panel for guiding water, liquid nutrient feedstock and the like down the first panel. In particular, the first liquid guiding means may be a series of parallel, U-shaped channels or grooves that extend between a top end and a bottom end of the supporting wall for evenly distributing water, liquid nutrient feedstock and the like along substantially the height and width of the supporting wall.

The first panel may comprise a substantially square or rectangular frame defining a top end, bottom end, and two opposing side ends, with the series of parallel channels or grooves extending between the top end and bottom end of the square or rectangular frame.

One of the top or bottom ends of the square or rectangular frame may include a male formation, with the other of the bottom or top ends including a complimentarily dimensioned female formation, the male and female formations being adapted to engage complimentarily dimensioned female and male formations respectively of vertically neighboring supporting walls.

Likewise, one of the side ends may include a male formation, with the other of the side ends including a complimentarily dimensioned female formation, the male and female formations being adapted to engage complimentarily dimensioned female and male formations respectively of horizontally neighboring supporting walls. Each male and female formation together may constitute a pivotal connection so that neighboring supporting walls are pivotally and slidingly displaceable relative to each other, both in a vertical plane and in a horizontal plane, thus allowing for a multitude of different structures to be built, depending on design requirements. The male formation may be a tongue formation, with the female formation being a groove formation.

The modular wall structure further may include at least one feeding pipe for supplying water, nutrient feedstock and the like to the series of parallel channels or grooves. In one embodiment of the invention the feeding pipe may be a substantially U-shaped feeding pipe which extends substantially about a periphery of the supporting wall, extending up one side end, along the top end, and down the opposing side end of the first panel. The feeding pipe may include a series of apertures which are aligned with the series of parallel channels or grooves, so as to carry water, liquid nutrient feedstock and the like through the feeding pipe and the series of apertures into the channels or grooves at the top end of the first panel, from where the water, liquid nutrient feedstock and the like is guided down the first panel by means of the channels or grooves.

The second panel may be a grid or lattice panel defining a plurality of small lattice windows extending through the second panel. The second panel may be connected to the first panel such that the second panel abuts the series of parallel channels or grooves of the first panel. In one embodiment of the invention, the second panel may fit into and releasably be connectable to the square or rectangular frame of the first panel by means of bolts, screws, a snap-fit connection, or the like. The lattice windows that extend through the second panel may be aligned with the parallel channels or grooves of the first panel. The lattice windows may constitute the first engaging means of the supporting wall for receiving at least a part of the plant container.

In one embodiment of the invention the second panel may include an insulation sheet that is dimensioned at least partially to cover a side of the second panel for insulating the supporting wall against a loss of water, liquid nutrient feedstock and the like being guided down the supporting wall. The insulation sheet may be ruptured on-site to accommodate plant containers in different design positions. More specifically, small holes may be made in the insulation sheet in alignment with the lattice windows only in those positions where plant containers are to protrude through the insulation sheet and connect to the supporting wall.

The plant container may include a substantially planar rear panel for abutting the supporting wall in use; and second engaging means that extend laterally outwardly from the rear panel. The second engaging means may be in the form of hooks, stubs, knobs or the like that are dimensioned to protrude through the lattice windows of the grid or lattice panel, thereby releasably connecting the plant container to the grid or lattice panel. It will be appreciated that the plant container can be connected to the grid or lattice panel in a variety of different positions. In a preferred embodiment of the invention, a plurality of plant containers are each releasably connected to the grid or lattice panel to form the vertical garden.

The plant container may include a set of liquid receiving apertures extending through the rear panel.

The second liquid guiding means may include liquid receiving means that are aligned with the liquid receiving apertures and that protrude laterally outwardly from the rear panel of the plant container, the arrangement being such that when the second engaging means of the plant container protrude through the lattice windows of the grid or lattice panel to connect the plant container to the supporting wall, the liquid receiving means of the plant container also protrude through the lattice windows of the grid or lattice panel and extend into the parallel channels or grooves of the first panel of the supporting wall, thereby guiding water, nutrient feedstock or the like that are channeled down the parallel channels or grooves of the first panel through the liquid receiving apertures into the plant container.

In one embodiment of the invention the liquid receiving means may be a set of wicks that protrude laterally outwardly from the rear panel of the plant container, and that are aligned with the liquid receiving apertures. In an alternative embodiment of the invention, the liquid receiving means may be channels or grooves that protrude laterally outwardly from the rear panel of the plant container, and are aligned with the liquid receiving apertures. In a preferred embodiment of the invention, the liquid receiving means of the plant container may also define the second engaging means.

The plant container also may include at least one, preferably a set of, liquid drainage apertures for draining water, nutrient feedstock or the like that are guided into the plant container, from a bottom part of the plant container. In this preferred embodiment of the invention, the second liquid guiding means also may include liquid drainage means that protrude laterally outwardly from the rear panel of the plant container below the liquid receiving means and aligned with the liquid drainage apertures. The liquid drainage means may be one, preferably a set of, liquid drainage channels, each of which may be aligned with a liquid drainage aperture.

The liquid drainage means may be characterized therein that when the plant container is connected to the supporting wall, the liquid drainage means also protrude through the lattice windows of the grid or lattice panel and extend into the parallel channels or grooves of the first panel of the supporting wall, thereby guiding excess water, nutrient feedstock or the like from a bottom part of the plant container back into the parallel channels or grooves of the first panel.

The modular wall system further may include at least one reservoir for housing water, liquid nutrient feedstock or the like, the reservoir being arranged at a bottom end of the supporting wall, underneath the series of parallel channels or grooves of the first panel, the arrangement being such that water, nutrient feedstock and the like that are channeled down the channels or grooves, is received within the reservoir. Moreover, the feeding pipe of the supporting wall may extend upwardly from the reservoir up one side end of the first panel, along the top end, down the opposing side end of the first panel and terminate in the reservoir, thus creating a closed water circuit within the modular wall system.

The modular wall system may include pumping means for pumping water from the reservoir through the feeding pipe.

The modular wall system also may include rain catcher trays that are releasably connectable to a top end of either the first or second panels of the supporting wall, and which are dimensioned to catch rain water. The rain catcher trays may be arranged in flow communication with the series of parallel channels or grooves of the first panel of the supporting wall, for guiding rain water into the closed water circuit of the modular wall system.

The modular wall system provides for a hydroponic growth system.

The modular wall system also provides for the inclusion of other components, such as water feature components, by connecting the same to the supporting wall in a similar manner to which the plant containers and rain catcher trays are connected.

### SPECIFIC EMBODIMENT OF THE INVENTION

Without limiting the scope thereof, the invention will now further be described by way of example only and with reference to the accompanying drawings in which—

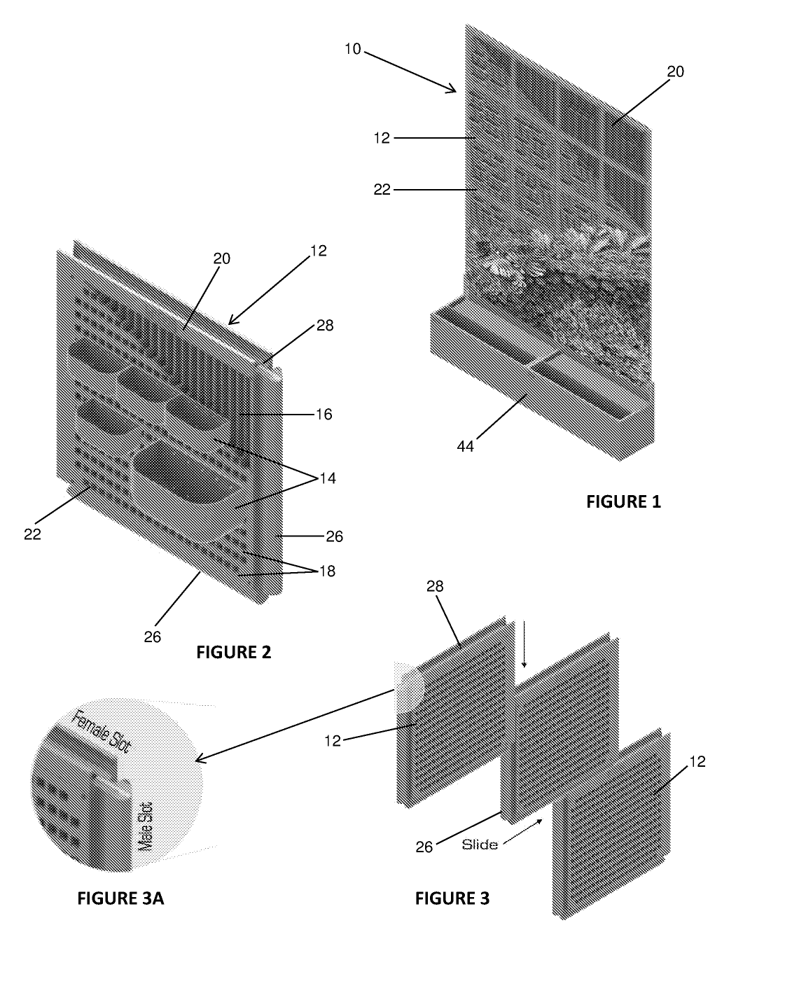

FIG. 1 is a partially sectioned perspective view of an assembled modular wall structure according to the invention;

FIG. 2 is partially sectioned perspective view of a supporting wall of the modular wall structure, illustrating the manner in which a variety of plant containers are releasably connectable to the supporting wall;

FIG. 3 is a perspective view of three supporting walls, illustrating the manner in which neighboring supporting walls can engage each other to form different structures, depending on on-site design requirements;

FIG. 3 is an exploded view of a corner of a wall unit of FIG. 3, illustrating the male and female formations;

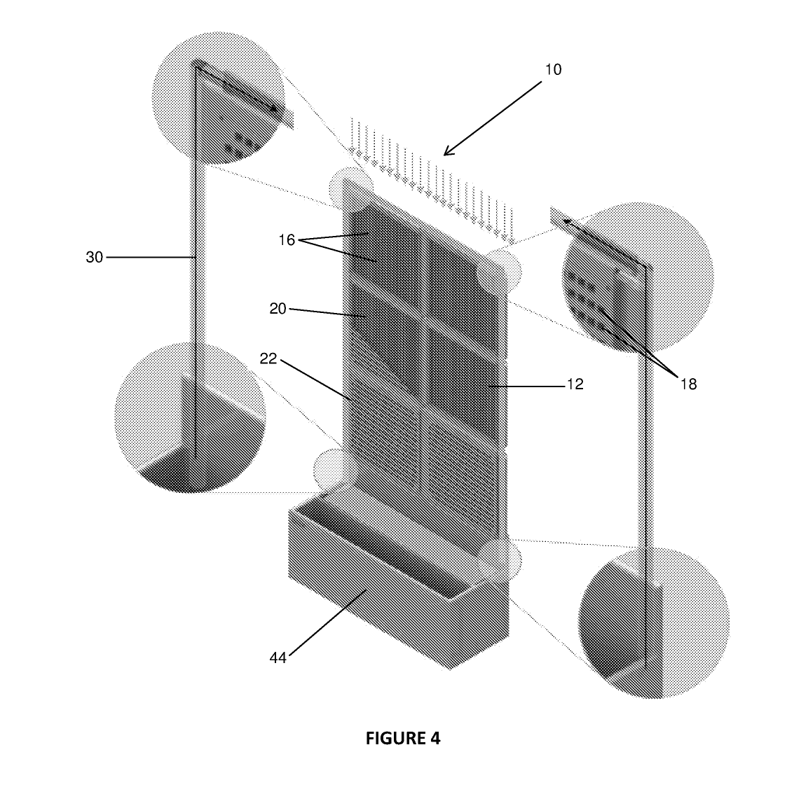

FIG. 4 is an exploded, partially sectioned, perspective view of a modular wall system according to the invention;

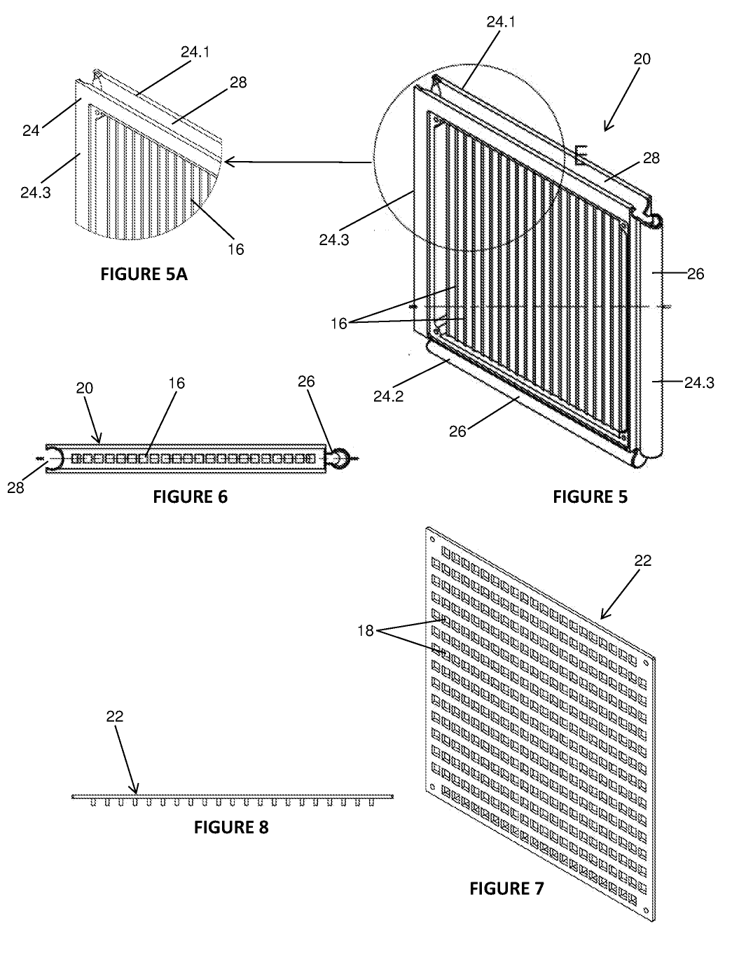

FIG. 5 is a perspective view of a first panel of the supporting wall;

FIG. 5A is an enlarged perspective view of a corner of the first panel of FIG. 5;

FIG. 6 is a sectional plan view from above of the first panel of FIG. 5;

FIG. 7 is a perspective view of one embodiment of a second panel of the supporting wall;

FIG. 8 is a sectional plan view from above of the second panel of FIG. 7;

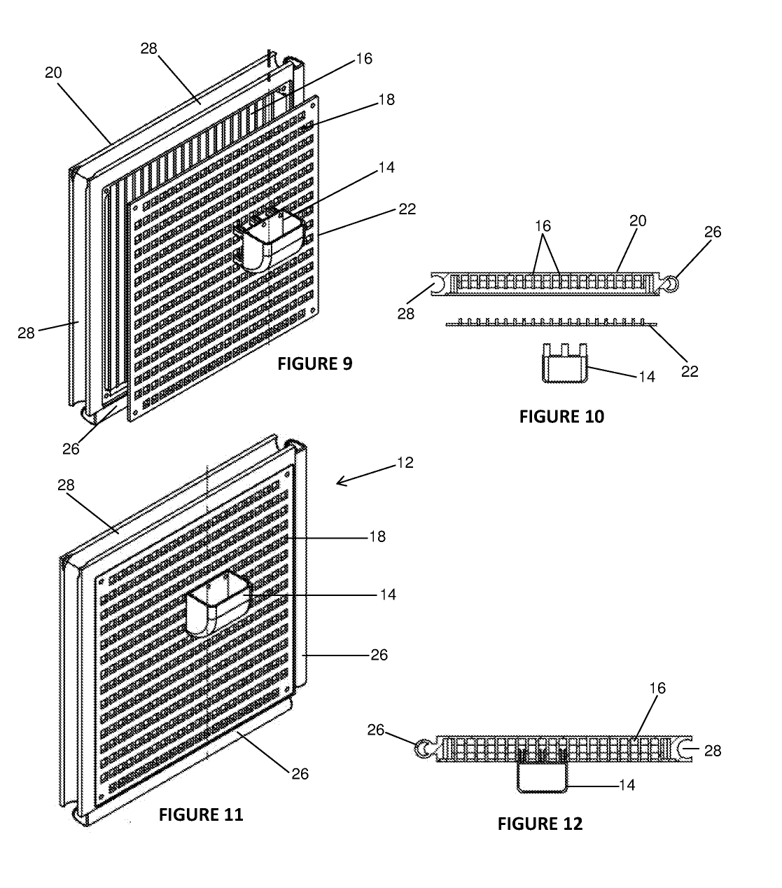

FIG. 9 is an exploded perspective view of the first panel, second panel and a plant container;

FIG. 10 is a sectional plan view from above of the first panel, second panel and the plant container of FIG. 9;

FIG. 11 is an assembled perspective view of the first panel, second panel and plant container of FIG. 9;

FIG. 12 is a sectional plan view from above of the first panel, second panel and the plant container of FIG. 11;

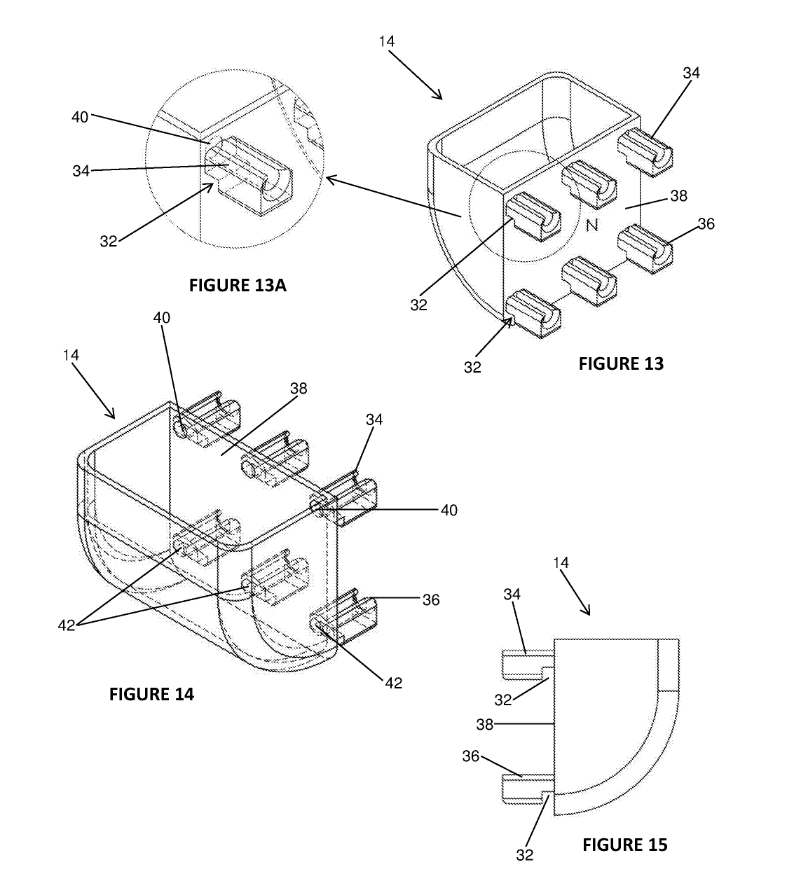

FIG. 13 is a rear perspective view of a plant container according to one embodiment of the invention;

FIG. 13A is an enlarged view of a second liquid guiding means of the plant container of FIG. 13;

FIG. 14 is a front perspective view of the plant container of FIG. 13;

FIG. 15 is a side elevation of the plant container of FIGS. 13 and 14;

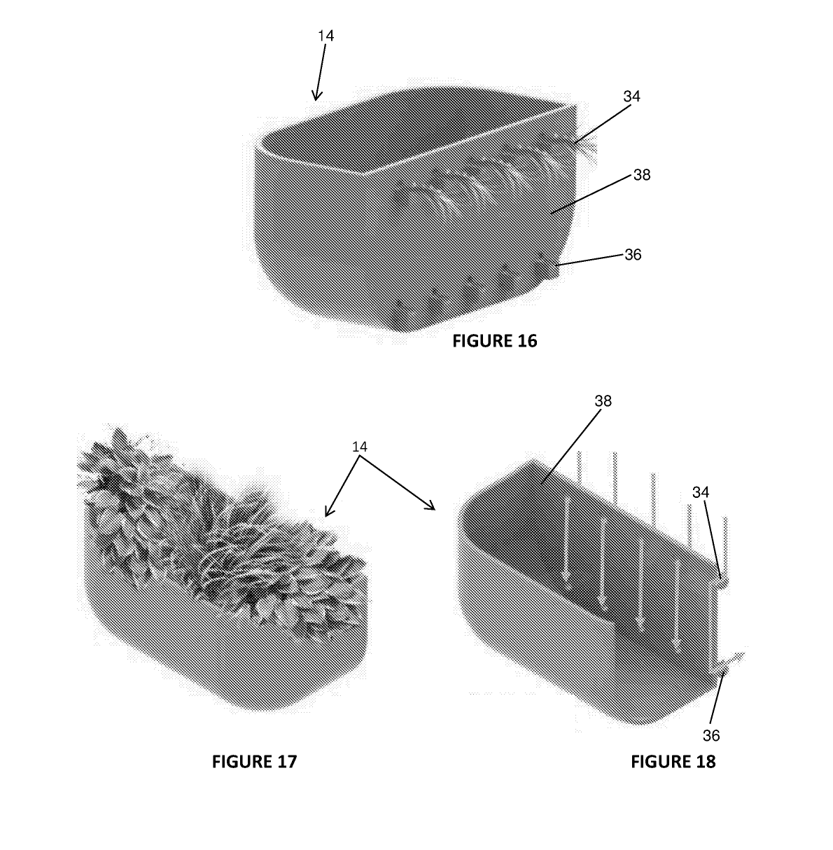

FIG. 16 is a rear perspective view of a plant container according to a second embodiment of the invention;

FIG. 17 is a front perspective view of a plant container according to the invention, illustrating the manner in which plant material is housed within the container in use;

FIG. 18 is a partially sectioned front perspective view of a plant container according to the invention, illustrating the manner in which water, nutrient feedstock and the like are guided through the plant container by means of the second liquid guiding means;

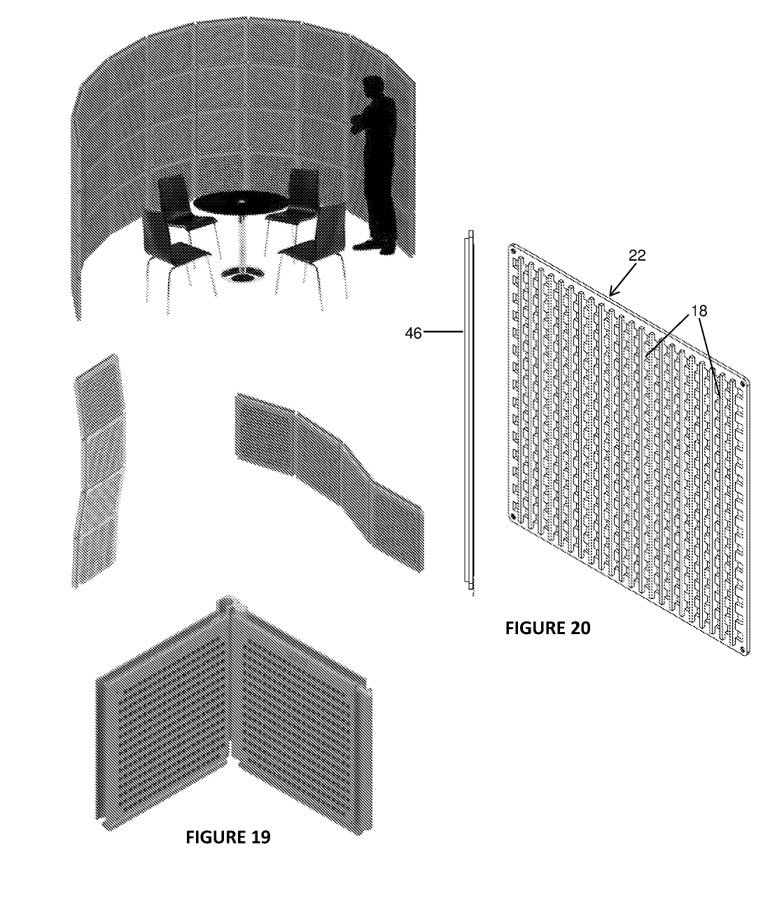

FIG. 19 illustrates four examples of how the modular wall units according to the invention can be positioned relative to each other, both in a vertical plane and in a horizontal plane, to accommodate different on-site design requirements; and

FIG. 20 is a perspective view of an alternative embodiment of a second panel of the supporting wall.

A modular wall system for supporting a vertical garden according to the invention is generally designated by reference numeral [10]. The modular wall system [10] comprises a supporting wall [12] and at least one plant container [14] for housing plant material. Each supporting wall [12] is designed to engage a maximum of four neighboring supporting walls [12] to form different structures, depending on on-site design requirements, as illustrated in FIGS. 3 and 19. Neighboring supporting walls [12] can engage each other either in a horizontal plane or in a vertical plane and are pivotally and slidingly displaceable relative to each other.

The supporting wall [12] includes first liquid guiding means [16] for guiding water, liquid nutrient feedstock and the like in the wall [12]; as well as first engaging means [18] for engaging the plant container [14] in various different positions on the supporting wall [12].

The supporting wall [12] is an upright, free standing wall, which optionally can be secured to a wall of a building or other rigid structure. The supporting wall [12] comprises a first panel [20], which includes the first liquid guiding means [16], and a second panel [22], which includes the first engaging means [18] for engaging the plant container [14]. The first and second panels [20, 22] may releasably be connectable to each other. Alternatively, the first and second panels [20, 22] may integrally be formed as a single unit to form the supporting wall [12].

The first liquid guiding means [16] is a series of parallel, U-shaped channels or grooves that extend vertically down the first panel [20] between a top end and a bottom end of the supporting wall [12] for evenly distributing water, liquid nutrient feedstock and the like along substantially the height and width of the supporting wall [12].

The first panel [20] comprises a substantially square or rectangular frame [24] defining a top end [24.1], bottom end [24.2], and two opposing side ends [24.3], with the series of parallel channels or grooves [16] extending between the top end [24.1] and bottom end [24.2] of the square or rectangular frame [24]. One of the top or bottom ends of the square or rectangular frame [24] includes a male formation [26], with the other of the bottom or top ends including a complimentarily dimensioned female formation [28], the male and female formations [26, 28] being adapted to engage complimentarily dimensioned female and male formations [28, 26] respectively of vertically neighboring supporting walls [12].

Likewise, one of the side ends [24.3] of the square or rectangular frame [24] includes a male formation [26], with the other of the side ends [24.3] including a complimentarily dimensioned female formation [28], the male and female formations [26, 28] being adapted to engage complimentarily dimensioned female and male formation [28, 26] respectively of horizontally neighboring supporting walls [12]. Each male and female formation [26, 28] together constitute a pivotal connection so that neighboring supporting walls [12] are pivotally and slidingly displaceable relative to each other, both in a vertical plane and in a horizontal plane, thus allowing for a multitude of different structures to be built, depending on design requirements. In the illustrated embodiment of the invention the male formation [26] is a tongue formation, with the female formation [28] being a groove formation.

The modular wall structure [10] further includes at least one feeding pipe [30] for supplying water, nutrient feedstock and the like to the series of parallel channels or grooves [16]. In one embodiment of the invention the feeding pipe [30] is a substantially U-shaped feeding pipe [30] which extends substantially about a periphery of the supporting wall [12], extending up one side end [24.3], along the top end [24.1], and down the opposing side end [24.3] of the first panel [20]. The feeding pipe [30] may include a series of apertures (not shown) which are aligned with the series of parallel channels or grooves [16], so as to carry water, liquid nutrient feedstock and the like through the feeding pipe [30] and into the channels or grooves [16] at the top end [24.1] of the first panel [20], from where the water, liquid nutrient feedstock and the like is guided down the first panel [20] by means of the channels or grooves [16].

The second panel [22] is a grid or lattice panel defining a plurality of small lattice windows [18] extending through the second panel [22], the small lattice windows [18] constituting the first engaging means [18] of the supporting wall [12] for receiving at least part of the plant container [14]. The second panel [22] is connected to the first panel [20] such that the second panel [22] abuts the series of parallel channels or grooves [16] of the first panel [20]. In particular, the second panel [22] fits into and is releasably connectable to the square or rectangular frame [24] of the first panel [20] by means of bolts, screws, a snap-fit connection, or the like. The lattice windows [18] that extend through the second panel [22] are aligned with the parallel channels or grooves [16] of the first panel [20].

In one embodiment of the invention, as illustrated in FIG. 20, the second panel [22] may include an insulation sheet [46] that is dimensioned at least partially to cover a side of the second panel [22] for insulating the supporting wall [12]. Small holes may be made in the insulation sheet [46] on-site and in alignment with the lattice windows [18] in those positions where plant containers [14] are to protrude through the insulation sheet [46] and connect to the supporting wall [12], thus insulating the supporting wall [12] against a loss of water, liquid nutrient feedstock and the like being guided down the supporting wall [12].

The plant container [14] comprises second engaging means [32] for releasably engaging the supporting wall [12], and second liquid guiding means [34, 36] extending from the plant container [14] into the first liquid guiding means [16] and dimensioned for guiding liquid from the first liquid guiding means [16] in the supporting wall [12] into the plant container [14], and from the plant container [14] back into the first liquid guiding means [16].

The plant container [14] comprises a substantially planar rear panel [38] for abutting the supporting wall [12] in use; and second engaging means [32] that extend laterally outwardly from the rear panel [38]. The second engaging means [32] is in the form of hooks, stubs, knobs or the like that are dimensioned to protrude through the lattice windows [18] of the grid or lattice panel [22], thereby releasably connecting the plant container [14] to the grid or lattice panel [22]. It will be appreciated that the plant container [14] can be connected to the grid or lattice panel [22] in a variety of different positions. In a preferred embodiment of the invention, a plurality of plant containers [14] are each releasably connected to the grid or lattice panel [22] to form a vertical garden.

The plant container [14] includes a set of liquid receiving apertures [40] extending through the rear panel [38].

The second liquid guiding means [34, 36] include liquid receiving means [34] that are aligned with the liquid receiving apertures [40] and that protrude laterally outwardly from the rear panel [38] of the plant container [14], the arrangement being such that when the second engaging means [32] of the plant container [14] protrude through the lattice windows [18] of the grid or lattice panel [22] to connect the plant container [14] to the supporting wall [12], the liquid receiving means [32] of the plant container [14] also protrude through the lattice windows [18] of the grid or lattice panel [22] and extend into the parallel channels or grooves [16] of the first panel [20] of the supporting wall [12], thereby guiding water, liquid nutrient feedstock or the like that are channeled down the parallel channels or grooves [16] of the first panel [20] through the liquid receiving apertures [40] into the plant container [14].

In one embodiment of the invention, as illustrated in FIG. 16, the liquid receiving means [34] is a set of wicks that protrude laterally outwardly from the rear panel [38] of the plant container [14], and that are aligned with the liquid receiving apertures [40]. In an alternative embodiment of the invention, as illustrated in FIGS. 13 to 15, the liquid receiving means [34] is channels or grooves [16] that protrude laterally outwardly from the rear panel [38] of the plant container [14], and are aligned with the liquid receiving apertures [40]. In a preferred embodiment of the invention, the liquid receiving means [34] of the plant container [14] also define the second engaging means [32].

The plant container [14] also includes at least one, preferably a set of, liquid drainage apertures [42] for draining water, liquid nutrient feedstock or the like that are guided into the plant container [14], from a bottom part of the plant container [14]. In this preferred embodiment of the invention, the second liquid guiding means [34, 36] also include liquid drainage means [36] that protrude laterally outwardly from the rear panel [38] of the plant container [14] below the liquid receiving means [34] and that are aligned with the liquid drainage apertures [42]. The liquid drainage means [36] is one, preferably a set of, liquid drainage channels, each of which is aligned with a liquid drainage aperture [42].

The liquid drainage means [36] is characterized therein that when the plant container [14] is connected to the supporting wall [12], the liquid drainage means [36] also protrude through the lattice windows [18] of the grid or lattice panel [22] and extend into the parallel channels or grooves [16] of the same, thereby guiding excess water, liquid nutrient feedstock or the like from a bottom part of the plant container [14] back into the parallel channels or grooves [16] of the first panel [20].

The modular wall system [10] further includes at least one reservoir [44] for housing water, liquid nutrient feedstock or the like, the reservoir [44] being arranged at a bottom end of the supporting wall [12], underneath the series of parallel channels or grooves [16] of the first panel [20], the arrangement being such that water, liquid nutrient feedstock and the like that are channeled down the channels or grooves [16], is received within the reservoir [44]. Moreover, the feeding pipe [30] of the supporting wall [12] extends upwardly from the reservoir [44] up one side end [24.3] of the first panel [20], along the top end [24.1], down the opposing side end [24.3] of the first panel [20] and terminates in the reservoir [44], thus creating a closed water circuit within the modular wall system [10].

The modular wall system [10] includes pumping means (not shown) for pumping water from the reservoir [44] through the feeding pipe [30].

When used outdoors, the modular wall system [10] also may include rain catcher trays (not shown) that are releasably connectable to a top end of the supporting wall [12], and which are dimensioned to catch rain water. The rain catcher trays may be arranged in flow communication with the series of parallel channels or grooves [16] of the first panel [20] of the supporting wall [12], for guiding rain water into the closed water circuit of the modular wall system [10].

The modular wall system [10] provides for a hydroponic growth system.

The modular wall system [10] also provides for the inclusion of other components, such as water feature components, by connecting the same to the supporting wall [12] in a similar manner to which the plant containers [14] and rain catcher trays are connected.

It will be appreciated that many other embodiments of the invention may be possible without departing from the spirit or scope of the invention as defined in the claims.

1. A modular wall system adapted for supporting a vertical garden, the modular wall system comprising—
a supporting wall comprising first liquid guiding means for guiding water, liquid nutrient feedstock and the like in the wall, and first engaging means for engaging a plant container in various different positions on the supporting wall; and at least one plant container for housing plant material, the plant container comprising second engaging means for releasably engaging the supporting wall, and second liquid guiding means extending from the plant container into the first liquid guiding means and dimensioned for guiding liquid from the first liquid guiding means in the supporting wall into the plant container.

2. The modular wall system according to claim 1 wherein the supporting wall includes connecting means for releasably connecting the supporting wall to a similar, neighboring supporting wall, either in a horizontal plane or in a vertical plane, the arrangement being such that neighboring supporting walls are pivotally and slidingly displaceable relative to each other.

3. The modular wall system according to claim 2 wherein the modular wall system comprises a plurality of inter-engaged supporting walls which are pivotally and slidingly displaceable relative to each other to form different architectural structures, depending on on-site design requirements.

4. The modular wall system according to claim 1 wherein the supporting wall is an upright, free standing wall, which optionally may be secured to a wall of a building or other rigid structure.

5. The modular wall system according to claim 1 wherein the supporting wall comprises a first panel, which includes the first liquid guiding means, and a second panel, which includes the first engaging means for engaging the plant container.

6. The modular wall system according to claim 5 wherein the first and second panels are either two distinct panels which are releasably connectable to each other, or alternatively are integrally formed as a single unit.

7. The modular wall system according to claim 5 wherein the first liquid guiding means is a channel or groove extending vertically down the first panel for guiding water, liquid nutrient feedstock and the like down the first panel.

8. The modular wall system according to claim 7 wherein the first liquid guiding means is a series of parallel, U-shaped channels or grooves which extend between a top end and a bottom end of the supporting wall for evenly distributing water, liquid nutrient feedstock and the like along substantially the height and width of the supporting wall.

9. The modular wall system according to claim 8 wherein the first panel comprises a substantially square or rectangular frame defining a top end, bottom end, and two opposing side ends, with the series of parallel channels or grooves extending between the top end and bottom end of the square or rectangular frame.

10. The modular wall system according to claim 9 wherein the second panel fits into and is releasably connectable to the square or rectangular frame of the first panel by means of bolts, screws or a snap-fit connection.

11. The modular wall system according to claim 9 wherein one of the top or bottom ends of the square or rectangular frame includes a male formation, with the other of the bottom or top ends including a complimentarily dimensioned female formation, the male and female formations being adapted pivotally and slidingly to engage complimentarily dimensioned female and male formations respectively of vertically neighboring supporting walls to form different architectural structures.

12. The modular wall system according to claim 9 wherein one of the side ends includes a male formation, with the other of the side ends including a complimentarily dimensioned female formation, the male and female formations being adapted pivotally and slidingly to engage complimentarily dimensioned female and male formations respectively of horizontally neighboring supporting walls to form different architectural structures.

13. The modular wall system according to claim 11 wherein male formation is a tongue formation and the female formation is a groove formation.

14. The modular wall system according to claim 1 wherein the system further includes at least one feeding pipe for supplying water, nutrient feedstock and the like to the first liquid guiding means.

15. The modular wall system according to claim 8 wherein the feeding pipe is a substantially U-shaped feeding pipe which extends substantially about a periphery of the supporting wall, extending up one side end, along the top end, and down the opposing side end of the first panel; and including a series of apertures in the feeding pipe which are aligned with the series of parallel channels or grooves, so as to carry water, liquid nutrient feedstock and the like through the feeding pipe and the series of apertures into the channels or grooves at the top end of the first panel, from where the water, liquid nutrient feedstock and the like is guided down the first panel by means of the channels or grooves.

16. The modular wall system according to claim 8 wherein the second panel is a grid or lattice panel which defines a plurality of small lattice windows extending through the second panel, the second panel being connected to the first panel such that the second panel abuts the series of parallel channels or grooves of the first panel and such that the lattice windows, which extend through the second panel, are aligned with the parallel channels or grooves of the first panel.

17. The modular wall system according to claim 16 wherein the lattice windows constitute the first engaging means of the supporting wall for receiving at least a part of the plant container.

18. The modular wall system according to claim 1 wherein the plant container includes a substantially planar rear panel for abutting the supporting wall in use and from which the second engaging means extend laterally outwardly in the form of hooks, stubs or knobs.

19. The modular wall system according to claim 16 wherein the second engaging means of the plant container is dimensioned to protrude through the lattice windows of the second panel, thereby releasably connecting the plant container to the second panel in a variety of different positions.

20. The modular wall system according to claim 18 wherein the plant container includes a set of liquid receiving apertures extending through the rear panel of the plant container.

21. The modular wall system according to claim 20 wherein the second liquid guiding means of the plant container include liquid receiving means which are aligned with the liquid receiving apertures and which protrude laterally outwardly from the rear panel of the plant container into the first liquid guiding means of the supporting wall.

22. The modular wall system according to claim 8 wherein the second engaging means of the plant container protrude through the lattice windows of the second panel to connect the plant container to the supporting wall, while the liquid receiving means of the plant container also protrude through the lattice windows of the second panel and extend into the parallel channels or grooves of the first panel of the supporting wall, thereby guiding water, nutrient feedstock or the like that are channeled down the parallel channels or grooves of the first panel through the liquid receiving apertures into the plant container.

23. The modular wall system according to claim 21 wherein the liquid receiving means is a set of wicks which protrude laterally outwardly from the rear panel of the plant container, and which are aligned with the liquid receiving apertures.

24. The modular wall system according to claim 21 wherein the liquid receiving means is a set of channels or grooves which protrude laterally outwardly from the rear panel of the plant container, and which are aligned with the liquid receiving apertures.

25. The modular wall system according to claim 24 wherein the liquid receiving means of the plant container also define the second engaging means.

26. The modular wall system according to claim 1 wherein the plant container includes at least one, preferably a set of, liquid drainage apertures for draining water, nutrient feedstock or the like that are guided into the plant container, from a bottom part of the plant container.

27. The modular wall system according to claim 26 wherein the second liquid guiding means of the plant container also include liquid drainage means which protrude laterally outwardly from the plant container below the liquid receiving means and which are aligned with the liquid drainage apertures.

28. The modular wall system according to claim 8 wherein the liquid drainage means comprise one, preferably a set of, liquid drainage channels, each of which is aligned with a liquid drainage aperture, the arrangement being such that when the plant container is connected to the supporting wall, the liquid drainage channels protrude through the lattice windows of the second panel and extend into the parallel channels or grooves of the first panel of the supporting wall, thereby guiding excess water, nutrient feedstock or the like from a bottom part of the plant container back into the parallel channels or grooves of the first panel.

29. The modular wall system according to claim 1 wherein the system further includes at least one reservoir for housing water, liquid nutrient feedstock or the like, the reservoir being arranged at a bottom end of the supporting wall, underneath the first liquid guiding means of the first panel, the arrangement being such that water, nutrient feedstock and the like that are channeled down the first liquid guiding means, are received within the reservoir.

30. The modular wall system according to claim 14 wherein the feeding pipe of the supporting wall extends upwardly from the reservoir up one side end of the supporting wall, along the top end, down the opposing side end of the supporting wall and terminates in the reservoir, thus creating a closed water circuit within the modular wall system.

31. The modular wall system according to claim 14 wherein the system includes pumping means for pumping water from the reservoir through the feeding pipe.

32. The modular wall system according to claim 1 wherein the system also includes rain catcher trays which are releasably connectable to a top end of the supporting wall and which are dimensioned to catch rain water, the rain catcher trays being arranged in flow communication with the first liquid guiding means of the supporting wall for guiding rain water into a closed water circuit of the modular wall system.

33. The modular wall system according to claim 16 wherein the second panel includes an insulation sheet that is dimensioned at least partially to cover a side of the second panel for insulating the supporting wall against a loss of water, liquid nutrient feedstock and the like being guided down the supporting wall, the insulation sheet being ruptured on-site to accommodate plant containers in different design positions on the supporting wall.

34. (canceled)
